(19) United States
(12) Patent Application Publication
(10) Pub. No.: US 2008/0033778 A1
(43) Pub. Date: Feb. 7, 2008

(54) Electronic Calendar Scheduling Using Autonomic Prioritization

(76) Inventors: Gregory J. Boss, American Fork, UT (US); David R. Burns, Cary, NC (US); Andrew R. Jones, Round Rock, TX (US); Kevin C. McConnell, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/461,560

(22) Filed: Aug. 1, 2006

(51) Int. Cl. G06F 15/02

(52) U.S. Cl. 705/9

(57) ABSTRACT

A method and system for scheduling electronic calendar events. An electronic calendar receives event information for a first calendar event including specified attendee(s), a priority level, an event time, and a time interval within which the event is to be scheduled. Responsive to detecting a scheduling conflict between the first calendar event and another calendar event, a reschedule procedure begins by determining whether the scheduling conflict can be resolved by modifying the specified event time to an another time within the specified time interval. Responsive to determining that the scheduling conflict cannot be resolved by changing the specified event time to another time within the specified time interval, the specified event priority level of the first calendar event is compared with event priority level of the conflicting calendar event to determine scheduling prioritization between the first calendar event and the conflicting calendar event.

### BACKGROUND OF THE INVENTION

1. Technical Field

The present invention relates generally to dynamically and autonomically adjusting electronic calendar entries. More particularly, the present invention relates to a system, method, and computer program product for prioritizing calendar events by applying specified rulesets.

2. Description of the Related Art

Busy employees and executives are often fully booked every hour of the day. When urgent business must be conducted, it is difficult to quickly schedule time on individuals' calendars, particularly on short notice. For meetings that involve multiple people even more complication exists in finding times mutually available. Adding in the complexities involved in prioritizing meetings for many people becomes a daunting inefficient manual task.

Secretaries often instant message individuals or call them on the phone to find out if they can skip a meeting in favor of another meeting. This can be time consuming for all parties involved and result in decreased productivity due to individuals missing meetings or rescheduling calls.

From the foregoing, it can be appreciated that a need exists for a system and method for automatically prioritizing calendar events. The present invention addresses this and other needs unresolved by the prior art.

### SUMMARY OF THE INVENTION

A method and system for scheduling electronic calendar events are disclosed herein. An electronic calendar receives event information for a first calendar event including specified attendee(s), a priority level, an event time, and a time interval within which the event is to be scheduled. Responsive to detecting a scheduling conflict between the first calendar event and another calendar event, a reschedule procedure begins by determining whether the scheduling conflict can be resolved by modifying the specified event time to an another time within the specified time interval. Responsive to determining that the scheduling conflict cannot be resolved by changing the specified event time to another time within the specified time interval, the specified event priority level of the first calendar event is compared with event priority level of the conflicting calendar event to determine scheduling prioritization between the first calendar event and the conflicting calendar event. If the system still does not find an available time in which the conflict can be resolved using event priority level comparisons, the electronic calendar system compares the job position of the individual requesting the first calendar event with the job positions of the conflicting event attendees. If the first calendar event requester has a hierarchically higher job position than the conflicting event attendees, the system schedules the first calendar event and reschedules the conflicting events. Executives and persons over a specified job ranking level can optionally disable the meeting override feature so that none of their meetings can be rescheduled.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram of a data processing system adapted to perform electronic calendar scheduling processing in accordance with the present invention;

FIG. 2 is a high-level block diagram depicting an exemplary calendar event having event information;

FIG. 3 is a high-level flow diagram illustrating steps performed during calendar scheduling in accordance with the present invention; and

FIG. 4 is a high-level flow diagram depicting scheduling prioritization such as may be implemented during the calendar scheduling process shown in FIG. 3 in accordance with the present invention.

### DETAILED DESCRIPTION OF ILLUSTRATIVE EMBODIMENT(S)

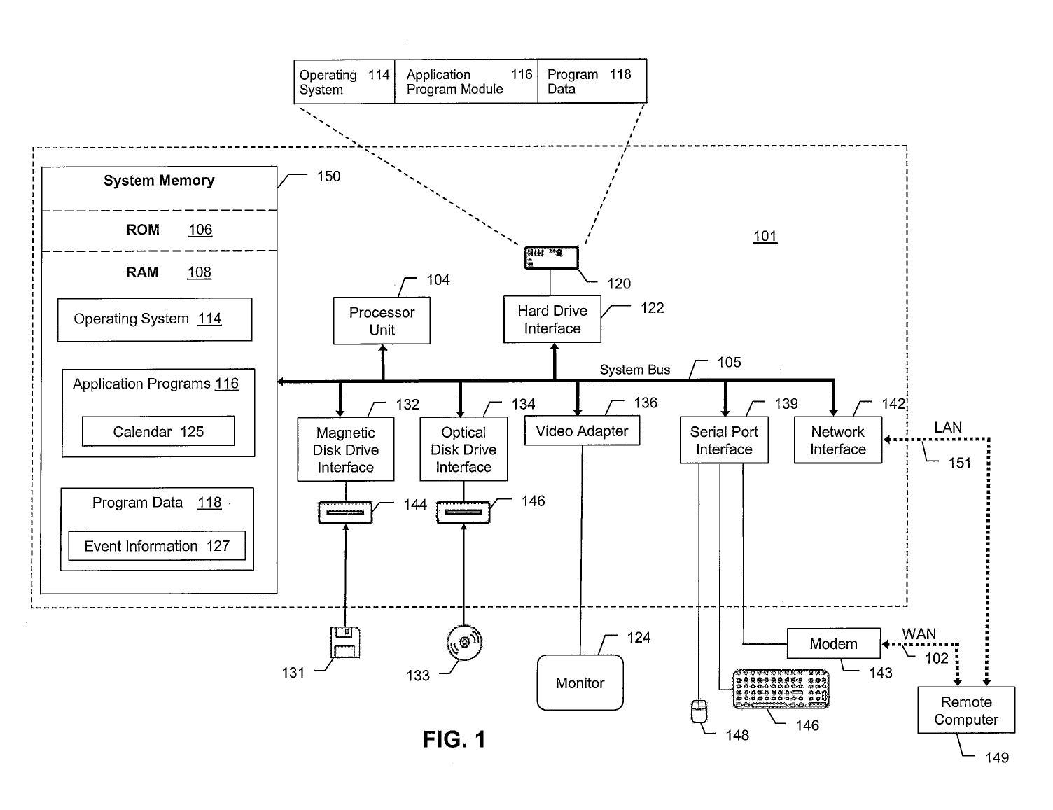

As explained in further detail below with reference to FIGS. 1-4, the present invention is directed to scheduling calendar events, and in particular, to scheduling a given calendar event in accordance with event information associated with the given calendar event and other scheduled calendar events.

With reference now to the figures, wherein like reference numerals refer to like and corresponding parts throughout, and in particular with reference to FIG. 1, there is illustrated an exemplary architecture of a data processing system 101 adapted for implementing the present invention. Specifically, data processing system 101 includes electronic and/or program product and instruction means and data for performing calendar scheduling processing in accordance with the present invention. For discussion purposes, data processing system 101 is described as a personal computer, such as a desktop or portable computer. However, as utilized herein, the terms “data processing system,” “computer,” and the like, are intended to mean essentially any type of computing device or machine that is capable of running a software product, including communication devices (e.g., pagers, telephones, electronic books, etc.) and other computer-based networked devices (e.g., handheld computers, Web-enabled televisions, home automation systems, multimedia viewing systems, etc.). Those skilled in the art will appreciate that the invention may be practiced with other computer system configurations, including hand-held devices, multiprocessor systems, microprocessor-based or programmable consumer electronics, minicomputers, mainframe computers, and the like.

The invention is described in the general context of a program running in cooperation with an operating system in a personal computer. Those skilled in the art will recognize that the invention may be implemented in combination with a variety of types of program modules including application programs such as calendar and scheduling applications often implemented in conjunction with email applications. Such program modules include routines, programs, components, data structures, etc. that perform particular tasks or implement particular abstract data types.

As illustrated in FIG. 1, data processing system 101 is generally configured as a personal computer having a processor unit 104, a system memory 150, and a system bus 105 that couples system memory 150 to processing unit 104. System memory 150 includes read only memory (ROM) 106 and random access memory (RAM) 108. Data processing system 101 further includes a hard disk drive 120, a magnetic disk drive 144, e.g., to read from or write to a removable disk 131, and an optical disk drive 146, e.g., for reading a CD-ROM disk 133 or to read from or write to other optical media. Hard disk drive 120, magnetic disk drive 144, and optical disk drive 146 are connected to system bus 105 by a hard disk drive interface 122, a magnetic disk drive interface 132, and an optical drive interface 134, respectively. The drives and their associated computer-readable media provide non-volatile storage for data processing system 101. While the above description of computer-readable media refers to an on-board hard disk, a removable magnetic disk, and a CD-ROM disk, it is understood by those skilled in the art that other types of media which are readable by a functionally equivalent computer, such as magnetic cassettes, flash memory cards, digital video disks, Bernoulli cartridges, and the like, may also be used in the exemplary computer operating environment.

A number of program modules may be stored in the drives and system memory 150, including an operating system 114, application program modules 116, and program data 118. Operating system 114 runs on processor 104 and is utilized to coordinate and provide control of various components within data processing system 101. Operating system 114 may be one of a variety of publicly or commercially available operating systems such as Linux, Unix®, Windows® XP, etc. An object oriented programming system such as Java may run in conjunction with operating system 114 and provide calls to the operating system from Java programs or applications executing on data processing system 101. Instructions for operating system 114 and other programs or applications are located on storage devices, such as hard disk drive 120, and may be loaded into system memory 150 for execution by processor 104.

A user may enter commands and information into data processing system 101 through a keyboard 146 and pointing device, such as a mouse 148. Other input devices (not shown) may include a microphone, joystick, game pad, satellite dish, scanner, or the like. These and other input devices are often connected to processing unit 104 through a serial port interface 139 that is coupled to system bus 105, but may be connected by other interfaces, such as a game port or a universal serial bus. A monitor 124 or other type of display device is also connected to system bus 105 via an interface, such as a video adapter 136.

Data processing system 101 may operate in a networked environment using logical connections to one or more remote computers, such as a remote computer 149. The remote computer 149 may be a server, a router, a peer device or other common network node, and typically includes many or all of the elements described relative to data processing system 101. The logical network connections depicted in FIG. 1 include a LAN 151 as well as a WAN 102. Such networking environments are commonplace in offices, enterprise-wide computer networks, Intranets and the Internet.

When used in a LAN networking environment, data processing system 101 is communicatively coupled to LAN 151 through a network interface 142. When used in a WAN networking environment, data processing system 101 typically includes a modem 143 or other means for establishing communications over WAN 102, such as the Internet. Modem 143, which may be internal or external, is connected to system bus 105 via serial port interface 139. In a networked environment, program modules depicted relative to data processing system 101, or portions thereof, may be stored in one or more remote (i.e., network distributed) memory storage devices. It will be appreciated that the network connections shown are exemplary and other means of establishing a communications link between the computers may be used.

In the depicted embodiment, application programs 116 include a calendar program 125, referred to herein alternately as a calendar module or electronic calendar. Calendar program 125 includes program modules and instructions enabling a client (i.e., a user of data processing system 101) to run an electronic calendar application that generates and maintains calendar event information for scheduled meetings, conference calls, etc. As explained in further detail below, a scheduling program such as calendar program 125 typically includes electronic processing and/or program instruction means that, responsive to being invoked, establish communication exchange with calendar resources including group calendar resources established and maintained over LAN 151 and/or WAN 102.

Once invoked, calendar program 125 performs tasks associated with scheduling calendar events. Such calendar events are identified and processed by calendar program 125 using sets of event information 127 associated with each calendar event. Event information 127 may be stored in any format that may be used by calendar program 125. For example, event information 127 may be stored in an application-specific format for calendar program 125. Conversely, event information 127 may be stored in a standardized format and be organized in fields, such as those found in a database, a spreadsheet, or similar applications.

The present invention provides a mechanism for scheduling electronic calendar events such as meetings, conference calls, etc. in an automated manner. In one embodiment, a calendar program such as calendar program 125 processes event information 127 for a given calendar event with event information associated with other calendar events to determine a correct scheduling in accordance with prioritization rules.

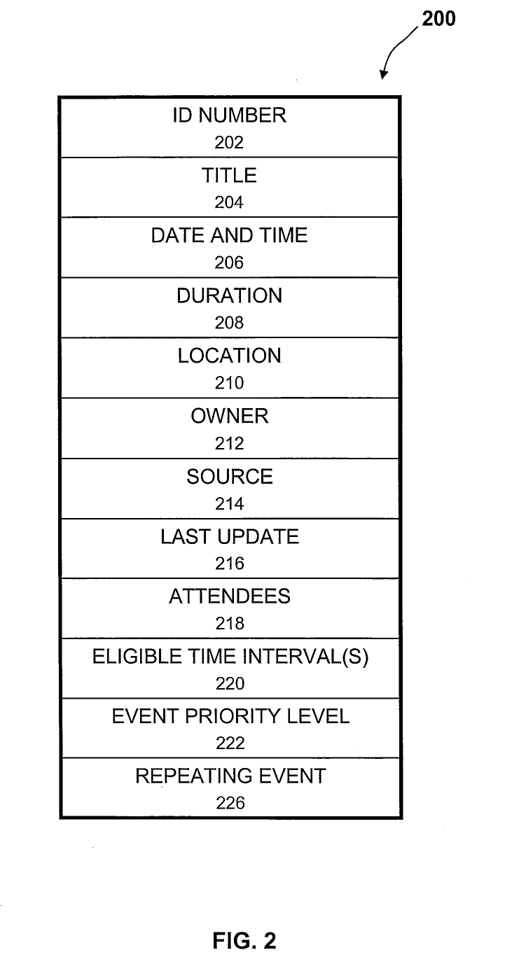

With reference now to FIG. 2, there is illustrated a high-level block diagram depicting an exemplary electronic calendar event 200 having associated event information. Such event information generally includes information that relates to or defines one or more electronic scheduling data associated with calendar event 200.

In the depicted embodiment, the event information includes an identification number 202, an event title 204, a date and time 206 including at least the time at which the event is scheduled to begin, a planned duration 208 of the event, a location 210 at which the event is to be held, an owner 212, a source 214, a last update 216, each of which is described in further detail below.

Identification number 202 preferably comprises a unique identifier, such as an alphanumeric sequence for referencing the electronic event. The identification number may be utilized by the calendaring system of the present invention to search for or and/or update a calendar event or event information associated with calendar events.

Event title 204 facilitates user identification of calendar event 200 by conveying, for example, the purpose of the event. An example title may read “Weekly Conference Call With Project Management.”

Date and time 206 may be used to indicate when calendar event 200 is scheduled to occur, particularly its start time. The date portion of data and time 206 may include a month, a day, and a year. The time portion may include a time of day to indicate, for example, the start or end of an electronic event.

Duration 208 is utilized to indicate the period over which calendar event 200 is anticipated to occur.

Location 210 may be utilized to indicate one or more locations where a physical occurrence relating to calendar event 200 takes place. Using the example above, the location associated with a calendar event named “Weekly Conference Call With Project Management” may be “conference room 110.”

Owner 212 may include one or more names or other identifiers for persons or entities authorized to access, modify, remove, or otherwise control event information pertaining to an electronic calendar event. The owner may be an individual, a group, or a collective entity (e.g., a company, a department, a municipality, a building, or a team). Owner 212 may comprise a single entity having full and exclusive authority to modify or remove other event information for calendar event 200, and/or different levels of control may be apportioned among one or multiple owners. Furthermore, one or more of the event information types (e.g. title, date and time, etc.) for calendar event 200 may have different and/or multiple owners.

Source 214 may identify the originator of calendar event 200, the location at which the event was created, or the location from which the event or associated event information was imported. For example, source 214 may include a link or a tag to an electronic calendar from which an electronic calendar event was imported. The source may be checked to determine whether a calendar event has been modified. For example, an implementation may compare some or all of the contents of calendar event 200 at source 214 with the contents of an imported electronic event (not depicted). More specifically, an implementation such as calendar program 125 may compare event information relating to a newly scheduled or updated calendar event (explained below) with event information for other associated calendar events within a given organization from both the source and the imported electronic event. In many instances, source 214 may correlate with owner 212.

Last update 216 indicates the last time calendar event 200, or its associated event information, was updated or modified. Last update 216 may be utilized to determine whether to update calendar event 200 or portions of the associated event information.

Event information may be initialized with default information that may be changed by a source or an owner. For example, duration 208 may include a default setting of one hour that may be changed by an owner to half an hour.

As depicted in FIG. 2, the event information for calendar event 200 further comprises an eligible time interval 220, a meeting priority level 222, and a repeating event indicator 226. Time interval 220 comprises a specified one or more date/time intervals during which calendar event 200 may be scheduled. For example, time interval 220 may specify two intervals as Mar. 7, 2006 8:00 A.M.-11:30 A.M. EST and Mar. 9, 2006 10:30 A.M.-2:00 P.M. EST as the periods during which calendar event 200 may be scheduled.

Event priority level 222 specifies an event priority value which can be linguistically descriptive and/or a numeric or otherwise quantitative type of prioritization. Example priority level values may be “Personal cannot be changed,” “Critical,” “Important,” “Normal,” and “Low,” or a numeric range such as 1 though 5.

Repeating event identifier 226 indicates whether or not calendar event 200 is a repeating event and preferably including scheduling parameters such as interval between events.

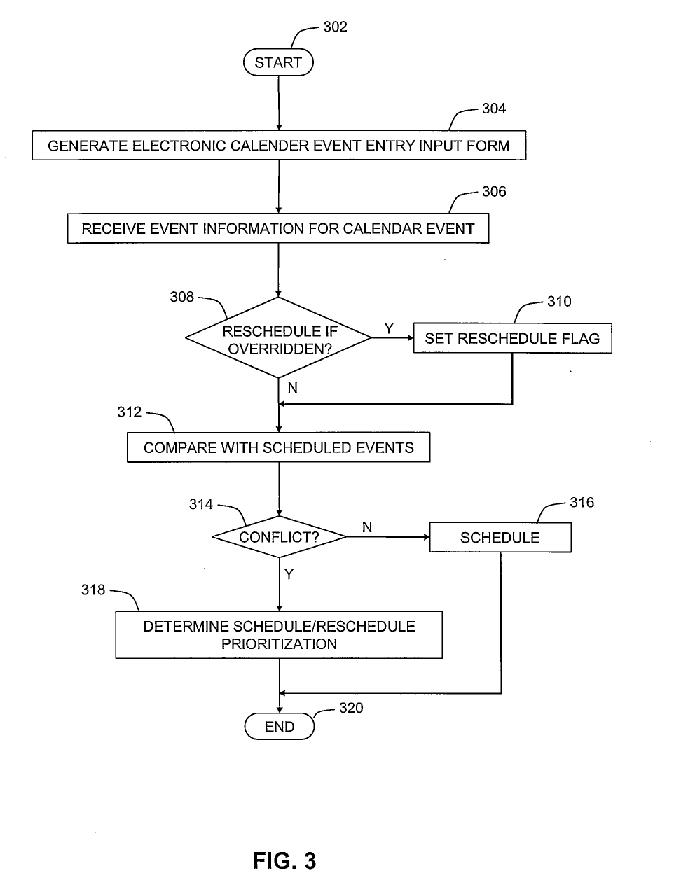

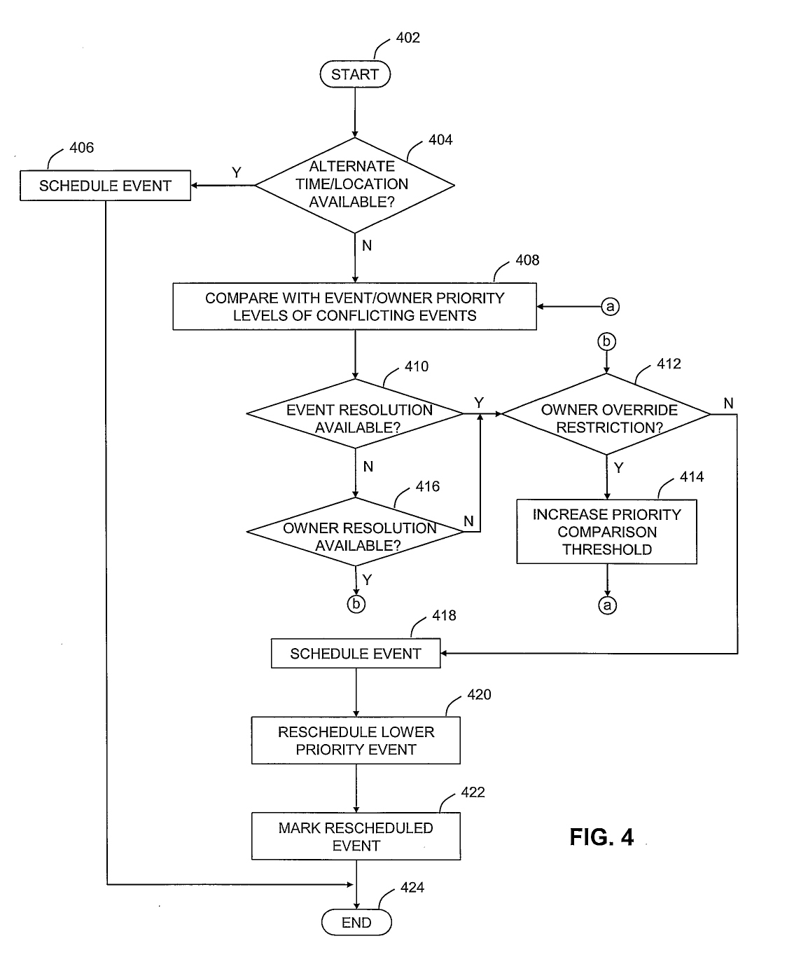

Electronic calendar events may be dependent or independent. An independent event does not relate to other calendar events, whereas, dependent events include event information that relates to one or more calendar events. An example of a dependent calendar event is an automatically generated reminder event for a scheduled meeting event. The reminder event is dependent on the meeting event at least in that if the meeting event is deleted before the reminder event is triggered then the reminder event is deleted also. As the reminder event example illustrates, dependent calendar events may include events that are automatically related. Dependent electronic events may also be manually related. As explained with reference to FIGS. 3 and 4, the scheduler of the present invention utilizes the foregoing event information items possibly in conjunction with other event information in a dependent manner to determine scheduling prioritization.

The event information blocks depicted in FIG. 2 are not necessarily an exclusive list, and other items commonly associated with, for example, calendars, tasks, and scheduling programs may be included as event information without departing from the spirit or scope of the present invention. An event need not include all of the event information described above. Further, the event information depicted in FIG. 2 as relating to a specific event also may relate to one or more other events.

The present invention provides a scheduling inter-dependency mechanism that enhances initial scheduling and rescheduling of electronically processed calendar events. Specifically, and referring now to FIG. 3, there is depicted a high-level flow diagram illustrating steps performed during calendar scheduling in accordance with the present invention. For purposes of illustration, the calendar scheduling process is described as performed by the data processing system 101 depicted in FIG. 1 utilizing calendar event information shown in FIG. 2. It should be noted, however, that the calendar scheduling mechanism and techniques disclosed and claimed herein may be implemented by a variety of physical and logical processing and event information configurations without departing from the spirit or scope of the present invention.

The scheduling process begins as shown at steps 302 and 304 with a calendaring application such as calendar program 125 generating an electronically displayed calendar event entry input form such as on display monitor 124. Typically, any combination of graphical user interface objects will be used for such display and will provide selectable user input objects that a user selects and inputs the event information, such as the event information for calendar event 200, for a given calendar event that is received as input data into calendar program 125 (step 306). Among the information received at 306 that may result in scheduling conflicts with previously scheduled events, the user enters or selects as the date and time 206, a specified time at which the object event is to occur and further specifies a length of time (e.g., one hour) as the duration 208. Further included in the information that may result in scheduling conflicts with previously scheduled events, the user specifies a desired location as the location 210 and the parties to the event as attendees 218.

In addition to entering the foregoing logistical event information that may give rise to scheduling conflicts, the user specifies an event priority level 222, eligible time intervals 220, and owner 212. In a preferred embodiment, the person(s) specified as owner 212 is/are the highest ranking persons among those specified in attendees 218 and the relative priority status is encoded or otherwise included in the information contained in owner 212. Event priority level 222 indicates the relative importance of the object event 200 and eligible time interval(s) 220 indicate one or more blocks of time (including dates) during which event 200 may be scheduled.

As shown at step 308, after receiving the user input event information, calendar program 125 determines whether or not event 200 should be marked to be rescheduled in case the event is subsequently overridden by a subsequent scheduling or rescheduling entry. In a preferred embodiment, the determination at step 308 by calendar program 125 is performed responsive to determining that calendar event 200 is a repeating event in accordance with repeating event indicator 226. Furthermore, the determination at step 308 may also be performed in accordance with priority information from event priority level 222. That is, responsive to detecting that calendar event 200 is repeating per repeating event indicator 226, calendar program 125 determines whether or not event 200 will be rescheduled in accordance with whether the associated event priority level 222 is at or above a specified threshold. Responsive to determining that event 200 is to be rescheduled if overridden, calendar program 125 sets a reschedule flag as depicted at step 310.

Proceeding as shown at step 312, calendar program 125 compares the event information received at step 306 with event information associated with previously scheduled events (not depicted). In one embodiment, at step 312, the foregoing date and time 206, duration 208, location 210, and attendees 218 are utilized by the calendar program 125 for comparison with corresponding event information for other scheduled events. If no scheduling conflict exists between the presently entered event 200 and the previously calendared events as determined at step 314, calendar event 200 is scheduled in accordance with the event information received at step 306 (step 316). If, as shown at step 318, a scheduling conflict is determined to exist at step 314, calendar program 125 either adjusts the schedule information for the presently entered event 200 or reschedules one or more conflicting events to resolve the conflict and the process ends as shown at step 320. The present invention employs a prioritization mechanism described in further detail below with reference to FIG. 4 to determine the necessary scheduling/rescheduling.

FIG. 4 is a high-level flow diagram depicting a scheduling prioritization process such as may be implemented by calendar program 125 during the calendar scheduling process shown in FIG. 3 in accordance with the present invention. The process begins as illustrated at steps 402 and 404 with a determination of whether the conflict can be resolved by adjusting the event information of newly entered (or newly rescheduled) event 200 without accounting for relative event priorities. If the scheduling conflict arises due solely to event location, calendar program 125 searches calendar data (not depicted) to determine whether an alternate location is available for the presently entered event 200. If so, calendar program 125 replaces the entry for location 210 with the available alternate location and schedules calendar event 200 as shown at step 406.

With continued reference to step 404, if no alternate location is determined to be available and/or the scheduling conflict is caused by a personnel scheduling conflict (i.e. one or more persons scheduled to attend different events at or near the same time), calendar program 125 determines whether an available alternate time slot is available within the time range(s) provided by eligible time interval(s) 220. To make this determination, calendar program 125 compares date and time 206, duration 208, and attendees 218 event information for event 200 with corresponding event information for other scheduled events including the conflicting events across each of eligible time interval(s) 220 to determine if an alternate scheduling time period is available for scheduling event 200 that avoids scheduling conflicts with the previously scheduled events. In response to finding an alternate scheduling time period that conforms to the requirements defined by eligible time interval(s) 220 and for which there are no scheduling conflicts with previously scheduled events, calendar program 125 replaces the entry for date and time 206 with a date and time corresponding to the alternate period and schedules calendar event 200 as shown at step 406.

If an alternate available scheduling time or location for event 200 cannot be found that preliminarily removes the conflict, the process continues as shown at step 408 with calendar program 125 comparing relative priority levels of the presently entered event 200 with priority levels of the one or more conflicting event(s). Specifically, the event priority level 222 of the presently entered calendar event 200 is compared with corresponding event priority information for the conflicting event(s) to determine whether or not the conflicting event(s) has a specified priority level below priority level 222 and at or below a specified lowest priority threshold. If the conflicting event(s) is/are found to be at or below priority level 222 and the specified priority threshold, an event reschedule resolution is available whereby the presently entered calendar event 200 may be scheduled in accordance with the originally entered event information and the conflicting event(s) is/are rescheduled. In a preferred embodiment, the conflicting event(s) are rescheduled using substantially the same procedure as for determining scheduling prioritization for calendar event 200 depicted in FIG. 4.

As shown at steps 410 and 412, in response to an available event priority resolution, calendar program 125 determines whether the information included in owner 212 or elsewhere in calendar event 200 includes an override restriction. If so, the priority threshold utilized for the event priority comparison at step 408 is incremented or otherwise increased, and the process repeats with a comparison of the conflicting event(s) priorities with the increased priority level threshold at step 408. In the case of no owner override restriction, and as depicted at steps 418 and 420, calendar program 125 schedules calendar event 200 using the originally entered event information and the conflicting event(s) is/are rescheduled. In a preferred embodiment, the conflicting event(s) are rescheduled using substantially the same procedure as for determining scheduling prioritization for calendar event 200 (i.e., the same procedure as depicted and described herein with reference to FIG. 4).

If as determined by one or more compare cycles through step 408, an event priority resolution is not available, a similar priority comparison may be conducted at step 408 using the status level of the respective owners of the conflicting events. Namely, a priority or status preferably associated with the highest ranking attendee may be included in the event information contained in owner 212 that may be compared to owner priority/status information for the conflicting event(s) in substantially the same manner as described for event priority comparisons. Similar to the event priority level resolution procedure, if an owner priority/status resolution is determined to be available (step 416), an owner override check is performed before scheduling/rescheduling (steps 412, 418, 420). For example, if an available time to resolve the conflict using event priority levels is not found, calendar program 125 checks the job position of an attendee and/or the individual requesting the event. If the individual is in a higher position than the attendees of the conflicting events, the system can override and schedule the high priority meeting. Executives over a specified level can optionally disable the meeting override feature so that none of their meetings can be rescheduled as shown at step 412. Following scheduling/rescheduling, and as depicted at step 422, calendar program 125 marks the displayed calendar objects corresponding to the one or more rescheduled events using a specified color or other visible highlighting feature to convey the occurrence of the rescheduling to the user and the process ends as shown at step 424.

The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method for scheduling electronic calendar events comprising:
receiving event information for a first calendar event including:
at least one specified attendee;
a specified event priority level;
a specified event time defining at least the start time of the event; and
a specified time interval within which the first calendar event is to be scheduled;
comparing the received event information with corresponding event information for at least one other calendar event; and
responsive to determining that a scheduling conflict exists between the first calendar event and at least one conflicting calendar event, commencing a reschedule procedure comprising:
determining whether the scheduling conflict can be resolved by replacing the specified event time for the first calendar event with another event time within the specified time interval; and
responsive to determining that the scheduling conflict cannot be resolved by replacing the specified event time for the first calendar event with another event time within the specified time interval, comparing the specified event priority level of the first calendar event with event priority levels of the at least one conflicting calendar event to determine scheduling prioritization between the first calendar event and the at least one conflicting calendar event.

2. The method of claim 1, further comprising, responsive to determining that the scheduling conflict can be resolved by replacing the specified event time for the first calendar event with another event time within the specified time interval, replacing the specified event time for the first calendar event with another event time within the specified time interval.

3. The method of claim 1, wherein the received event information for the first calendar event further includes a specified event location, said method further comprising, responsive to determining that a scheduling conflict exists between the first calendar event and at least one conflicting calendar event based only on event location:
determining whether a location different from the specified location is available for said first calendar event; and
responsive to a different location being available, replacing the specified location with the different location within the event information of the first calendar event.

4. The method of claim 1, further comprising responsive to the event priority levels of the at least one conflict calendar event being lower than the specified event priority level for the first calendar event, scheduling the first calendar event using the received event information and rescheduling the at least one conflicting calendar event to resolve the scheduling conflict.

5. The method of claim 4, further comprising highlighting a displayed object corresponding to the rescheduled at least one conflicting calendar event.

6. The method of claim 4, said comparing the specified event priority level of the first calendar event with event priority levels of the at least one conflicting calendar event comprising comparing the event priority levels of the at least one conflicting calendar events with a priority level threshold and responsive to none of the priority levels of the at least one conflicting calendar events being equal to or lower than the priority level threshold, increasing the priority level threshold and repeating comparing step.

7. The method of claim 1, further comprising responsive to the event priority levels of the at least one conflict calendar event being equal to or greater than the specified event priority level for the first calendar event:
comparing the job position of a person requesting the first calendar event with the job positions of one or more persons attending the conflicting calendar events, wherein the job positions of the person requesting the first calendar event and the job positions of the one or more persons attending the conflicting calendar events are hierarchically comparable; and
responsive to the job position of the person requesting the first calendar event being hierarchically higher that the job positions of the one or more persons attending the conflicting calendar events, scheduling the first calendar event using the received event information and rescheduling the at least one conflicting calendar event to resolve the scheduling conflict.

8. A system for scheduling electronic calendar events comprising:
means for receiving event information for a first calendar event including:
at least one specified attendee;
a specified event priority level;
a specified event time defining at least the start time of the event; and
a specified time interval within which the first calendar event is to be scheduled;
means for comparing the received event information with corresponding event information for at least one other calendar event; and
means responsive to determining that a scheduling conflict exists between the first calendar event and at least one conflicting calendar event, for commencing a reschedule procedure comprising:
means for determining whether the scheduling conflict can be resolved by replacing the specified event time for the first calendar event with another event time within the specified time interval; and
means responsive to determining that the scheduling conflict cannot be resolved by replacing the specified event time for the first calendar event with another event time within the specified time interval, for comparing the specified event priority level of the first calendar event with event priority levels of the at least one conflicting calendar event to determine scheduling prioritization between the first calendar event and the at least one conflicting calendar event.

9. The system of claim 8, further comprising, means responsive to determining that the scheduling conflict can be resolved by replacing the specified event time for the first calendar event with another event time within the specified time interval, for replacing the specified event time for the first calendar event with another event time within the specified time interval.

10. The system of claim 8, wherein the received event information for the first calendar event further includes a specified event location, said system further comprising means responsive to determining that a scheduling conflict exists between the first calendar event and at least one conflicting calendar event based only on event location for:
determining whether a location different from the specified location is available for said first calendar event; and
responsive to a different location being available, replacing the specified location with the different location within the event information of the first calendar event.

11. The system of claim 8, further comprising means responsive to the event priority levels of the at least one conflict calendar event being lower than the specified event priority level for the first calendar event, for scheduling the first calendar event using the received event information and rescheduling the at least one conflicting calendar event to resolve the scheduling conflict.

12. The system of claim 11, further comprising means for highlighting a displayed object corresponding to the rescheduled at least one conflicting calendar event.

13. The system of claim 11, said means for comparing the specified event priority level of the first calendar event with event priority levels of the at least one conflicting calendar event comprising means for comparing the event priority levels of the at least one conflicting calendar events with a priority level threshold and responsive to none of the priority levels of the at least one conflicting calendar events being equal to or lower than the priority level threshold, increasing the priority level threshold and repeating comparing step.

14. The system of claim 8, further comprising means responsive to the event priority levels of the at least one conflict calendar event being equal to or greater than the specified event priority level for the first calendar event for:
comparing the job position of a person requesting the first calendar event with the job positions of one or more persons attending the conflicting calendar events, wherein the job positions of the person requesting the first calendar event and the job positions of the one or more persons attending the conflicting calendar events are hierarchically comparable; and
responsive to the job position of the person requesting the first calendar event being hierarchically higher that the job positions of the one or more persons attending the conflicting calendar events, scheduling the first calendar event using the received event information and rescheduling the at least one conflicting calendar event to resolve the scheduling conflict.

15. A computer-readable medium having encoded thereon computer-executable instructions for scheduling electronic calendar events, said computer-executable instructions performing a method comprising:
receiving event information for a first calendar event including:
at least one specified attendee;
a specified event priority level;
a specified event time defining at least the start time of the event; and
a specified time interval within which the first calendar event is to be scheduled;
comparing the received event information with corresponding event information for at least one other calendar event; and
responsive to determining that a scheduling conflict exists between the first calendar event and at least one conflicting calendar event, commencing a reschedule procedure comprising:
determining whether the scheduling conflict can be resolved by replacing the specified event time for the first calendar event with another event time within the specified time interval; and
responsive to determining that the scheduling conflict cannot be resolved by replacing the specified event time for the first calendar event with another event time within the specified time interval, comparing the specified event priority level of the first calendar event with event priority levels of the at least one conflicting calendar event to determine scheduling prioritization between the first calendar event and the at least one conflicting calendar event.

16. The computer-readable medium of claim 15, further comprising, responsive to determining that the scheduling conflict can be resolved by replacing the specified event time for the first calendar event with another event time within the specified time interval, replacing the specified event time for the first calendar event with another event time within the specified time interval.

17. The computer-readable medium of claim 15, wherein the received event information for the first calendar event further includes a specified event location, said method further comprising, responsive to determining that a scheduling conflict exists between the first calendar event and at least one conflicting calendar event based only on event location:
determining whether a location different from the specified location is available for said first calendar event; and
responsive to a different location being available, replacing the specified location with the different location within the event information of the first calendar event.

18. The computer-readable medium of claim 15, said method further comprising, responsive to the event priority levels of the at least one conflict calendar event being lower than the specified event priority level for the first calendar event, scheduling the first calendar event using the received event information and rescheduling the at least one conflicting calendar event to resolve the scheduling conflict.

19. The computer-readable medium of claim 18, said method further comprising highlighting a displayed object corresponding to the rescheduled at least one conflicting calendar event.

20. The computer-readable medium of claim 18, said comparing the specified event priority level of the first calendar event with event priority levels of the at least one conflicting calendar event comprising comparing the event priority levels of the at least one conflicting calendar events with a priority level threshold and responsive to none of the priority levels of the at least one conflicting calendar events being equal to or lower than the priority level threshold, increasing the priority level threshold and repeating comparing step.
